(19) United States
(12) Patent Application Publication
(10) Pub. No.: US 2008/0294520 A1
(43) Pub. Date: Nov. 27, 2008

(54) MOBILE DISPLAY ADVERTISING SYSTEM AND METHOD

(76) Inventors: James H. Power, Wading River, NY (US); Martin R. Geissler, Fairfax, VA (US); Mark E. Olds, South Riding, VA (US)

Correspondence Address: Muncy, Geissler, Olds & Lowe, PLLC, P.O. BOX 1364, FAIRFAX, VA, 22038-1364, US

(21) Appl. No.: 11/840,869

(22) Filed: Aug. 17, 2007

Related U.S. Application Data
(60) Provisional application No. 60/838,156, filed on Aug. 17, 2006.

(51) Int. Cl. G06Q 30/00; G06F 3/14

(52) U.S. Cl. 705/14

(57) ABSTRACT

An advertisement display apparatus is disclosed that includes a display screen for displaying advertising content, at least one radiation intensity sensor for measuring incident radiation, and a position adjustment device for adjusting a viewing angle of the display screen on the basis of the measured incident radiation to thereby minimize glare on the display screen.

### CROSS-REFERENCE TO RELATED APPLICATIONS

This application claims priority under 35 U.S.C. § 119 to U.S. Provisional Application No. 60/838,156, entitled “Mobile Multi-Display Advertising System and Method,” filed on Aug. 17, 2006, the entirety of which is incorporated by reference herein.

### BACKGROUND

This description relates to a mobile display advertising system, and more specifically to a system for controlling a mobile display advertising system.

In the fields of marketing and advertising, attempts are continually being made to cost effectively increase sales of goods and services. This is typically achieved through advertising campaigns designed to maximize the exposure of a particular good or service to a target consumer group.

Many different marketing and advertising schemes have been devised and broadly implemented in an effort to find the most effective and least costly way of increasing consumer exposure to the particular good or service to thereby increase sales. One of the more popular forms of advertising is display advertising on, for example, billboards. Display advertising, however, has its limitations. For example, billboards that are fixed to land and buildings are restrained in their movement and as such, these advertising methods are successful to the extent that they are placed in locations that are heavily traveled by pedestrians or automobiles. Advertising displays are known to be time and location sensitive. As such, stationary displays, like billboards, are disadvantaged over mobile displays in that they are unable to efficiently deliver the intended message to a targeted audience in desired geographic zones at specified times, which would serve to maximize the exposure of the advertisement to the targeted consumer group, thus increasing the potential of sales.

U.S. Pat. No. 6,060,993, which is herein incorporated by reference, discloses one possible system for displaying messages in advertisements on mobile signs, such as those placed on the tops of motor vehicles. In this system a geographic area is divided up into separate zones and when a mobile unit makes a transition from one zone into another, a controller determines when such a transition has been made and a message is displayed depending on which zone the vehicle is in and depending on which time it is.

U.S. Publication No. 2004/0036622, which is also herein incorporated by reference, discloses another vehicle display system to show messages on electronic displays. In this system, a display's current geographical location is determined, which determination is then utilized to select which messages are shown in the display. Further, the system allows advertisers to upload message content and to select a time and place at which the messages are to be shown.

However, these systems disclosed by the prior art fail to recognize the effects of glare, for example from solar radiation, which can result in that the display screen is completely unviewable to the targeted audience.

Furthermore, the prior art also fails to recognize that vehicles such as subways, buses, and taxis, are inefficient in maximizing the exposure of advertising images to a targeted consumer group because they are constrained by traffic, the images being displayed are often blurred by the high rate of speed of the vehicle, or because of the size limitations imposed by the vehicles themselves or by government regulations.

### SUMMARY

In one general aspect, an advertisement display apparatus includes a display screen for displaying advertising content, at least one radiation intensity sensor for measuring incident radiation, and a position adjustment device for adjusting a viewing angle of the display screen on the basis of the measured incident radiation to thereby minimize glare on the display screen.

In another general aspect, a watercraft includes a display apparatus that is mounted on the watercraft, the display apparatus having at least two display screens such that each display screen is viewable from an opposite sides of the watercraft. The different advertising content is displayed on each display screen on the basis of a travel direction of the watercraft.

In another general aspect, a display apparatus includes an upper cross member being rigidly mounted to a watercraft and a plurality of roller screens being provided on each side of the watercraft. At least one of the roller screens on each side has different advertising content printed thereon than another roller screen from the same side. In addition, at least one of the roller screens from each side of the watercraft is extended towards the upper cross member in order to display the advertising content printed thereon.

In one general aspect, an advertisement display apparatus includes a display screen for displaying advertising content, at least one radiation intensity sensor for measuring incident radiation, and a position adjustment device for adjusting a viewing angle of the display screen on the basis of the measured incident radiation to thereby minimize glare on the display screen.

Implementations of this aspect may include one or more of the following features. For example, the advertisement display apparatus may be provided on a vehicle. The advertisement display apparatus may be fixedly mounted to the vehicle. The display screen may include a cathode ray tube, a liquid crystal display, a plasma display, an electrostatic marking film, a preprinted film, and/or a mesh screen. A controller may control the advertising content that is displayed on the display screen. The advertising content may be stored within the controller or may be provided on-demand or periodically to the controller via a network, e.g., through a wireless telecommunications network. The advertising content that is displayed may be displayed on the basis of a particular location and/or travel direction of the advertisement display apparatus. The location and travel direction may be determined on the basis of GPS signals, and/or LORAN, such as LORAN-C.

In another general aspect, a watercraft includes a display apparatus being mounted on the watercraft, the display apparatus having at least two display screens such that each display screen is viewable from an opposite sides of the watercraft. The watercraft includes a travel direction detector for detecting a travel direction of the watercraft. Different advertising content is displayed on each display screen on the basis of a travel direction of the watercraft.

Implementations of this aspect may include one or more of the following features. For example, each display screen may be viewable from locations that are at least perpendicular to the travel direction of the watercraft. The display apparatus may comprise an electronic display apparatus, such as an LED array, LCD screen, etc., configured to selectively display different advertising content on each display screen on the basis of travel direction. The display apparatus may be configured to selectively display different advertising content on each display screen on the basis of one or more of incident radiation, watercraft position, and/or current date and time. The display apparatus may be configured to selectively display different advertising content on each display screen on the basis of one or more of incident radiation, watercraft position, and/or current date and time. The watercraft may include a controller, the controller being configured to selectively control the content of each of the display screens of the display apparatus. The controller may be operatively connected to a network, the controller being configured to receive content for display on one or more of the display screens through the network.

The display apparatus may further include an upper cross member being rigidly mounted to the watercraft, and the display screens comprise roller screens being provided on each side of the watercraft, at least one of the roller screens on each side having different advertising content printed thereon than another roller screen from the same side. At least one of the roller screens from each side of the watercraft is extended towards the upper cross member in order to display the advertising content printed thereon. Based on a position of the watercraft, a direction of the watercraft, and/or a time of day, the roller mesh screens may be automatically extended to display different advertising content. The roller screens may be mesh screens providing an electronic display and/or being controlled to move between various display positions electronically.

In another general aspect, in a method for displaying advertising content on a display apparatus mounted on a watercraft, the display apparatus having at least two display screens such that each display screen is viewable from opposite sides of the watercraft, the method includes detecting a travel direction of the watercraft with a travel detection device, receiving an indication for initiating the display of content on each of the display screens at a controller on the watercraft. Different content is displayed on each display screen on the basis of the travel direction of the watercraft.

Implementation of this aspect may include one or more of the following features. For example, different content can be selectively displayed on each display screen on the basis of one or more of incident radiation, watercraft position, current date and time, and/or on-demand content received through a network operatively connected to the controller. For example, multiple users may actively bid and/or submit content for display on the watercraft. In this scenario, a user may submit content for display on a nearby watercraft through a client device, such as a computer, PDA, or mobile telecommunications device. The content may be displayed on demand, e.g., in response to a specific user's request that is received through a network and approved for display. The content may be approved after having been filtered for profanity, content limitations such as a size or fonts, and/or after having received acceptable payment for the content, such as through a winning on-line auction or after meeting a minimum purchase price.

### BRIEF DESCRIPTION OF THE DRAWINGS

Further aspects and advantages will become apparent upon reading the following detailed description taken in conjunction with the accompanying drawings summarized below.

FIG. 1 is a block diagram of an exemplary controller system;

FIG. 2 is a schematic view of a display screen being oriented with respect to a target audience;

FIG. 3 is a view of an exemplary barge comprising a display screen;

FIG. 4 is a view of an exemplary self-propelled watercraft, having an integrated display screen;

FIG. 5 is a view of an exemplary display apparatus having displayed content on each display screen;

FIG. 6 illustrates an exemplary display screen for a watercraft;

FIGS. 7 and 8 illustrate exemplary display screens for a watercraft; and

FIG. 9 illustrates an exemplary display screen for a building.

### DETAILED DESCRIPTION

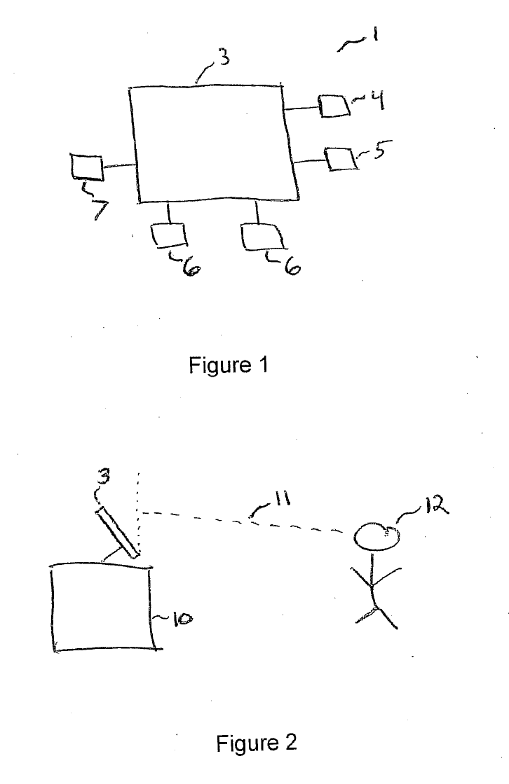

FIG. 1 illustrates a block diagram of a controller system 1 according to a first embodiment. Shown therein is a display screen 3, a controller 4, a position determining device 5, at least one radiation intensity sensor 6, and a position adjustment device 7.

The display screen 3, which is mounted to a vehicle 10, can be implemented by many different technologies, such as cathode ray tubes, liquid crystal displays, plasma displays, electrostatic marking films, preprinted films, etc., in order to present a particular advertisement message to a viewing audience. In this example embodiment, the controller 4 controls the advertising content that is provided to the display screen 4. The advertising content may be stored within the controller 4, or may be provided to the controller via a network.

The radiation intensity sensor 6 can be mounted directly to the display 3 or in close proximity thereto. The radiation intensity sensor 6 measures incident radiation, for example solar radiation or other light radiation. On the basis of a measured radiation by the radiation intensity sensor 6, a vertical and horizontal viewing angle 11 of the display screen 3 is adjusted by the position adjustment device 7 (as indicated by the dotted line in FIG. 2) in order to minimize glare on the display screen 3 to thereby improve the viewability of the advertisement message for a target audience 12. The position adjustment device 7 can be formed of actuators, hydraulics, gears, motors, etc. in order to adjust the horizontal and vertical viewing angle of the display screen 3.

In order to determine an optimal vertical and horizontal viewing angle 11 of the display screen 3, a single radiation intensity sensor 6 may be used to determine whether or not the effects of glare from the radiation has been minimized on the display screen 3, in that the vertical and horizontal viewing angle 11 of the display screen 3 is substantially continuously changed and whereby a previously measured radiation intensity is compared to a current measured radiation intensity. Two or more radiation intensity sensors 6 can also be utilized and on a basis of a comparison between measured radiation intensity values from each of the radiation intensity sensors 6, a determination of the optimal viewing angle 11 can be made.

Alternatively, in order to reduce the trial and error procedure as described above, the viewing angle 11 of the display screen 3 can be adjusted on the basis of an orientation of the vehicle and a solar position, whereby the solar position can be determined from database tables. Thus, an initial viewing angle adjustment direction can be determined, and then, on the basis of the measured radiation by the radiation intensity sensor 6, the viewing angle 11 of the display screen is adjusted towards the initial viewing angle adjustment direction.

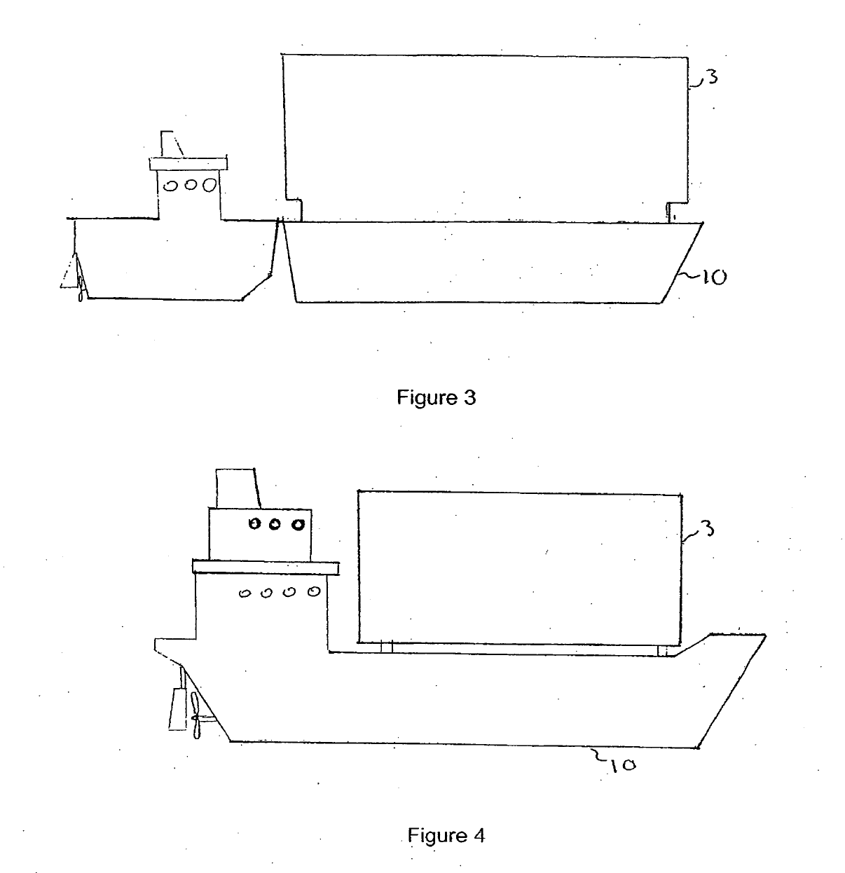

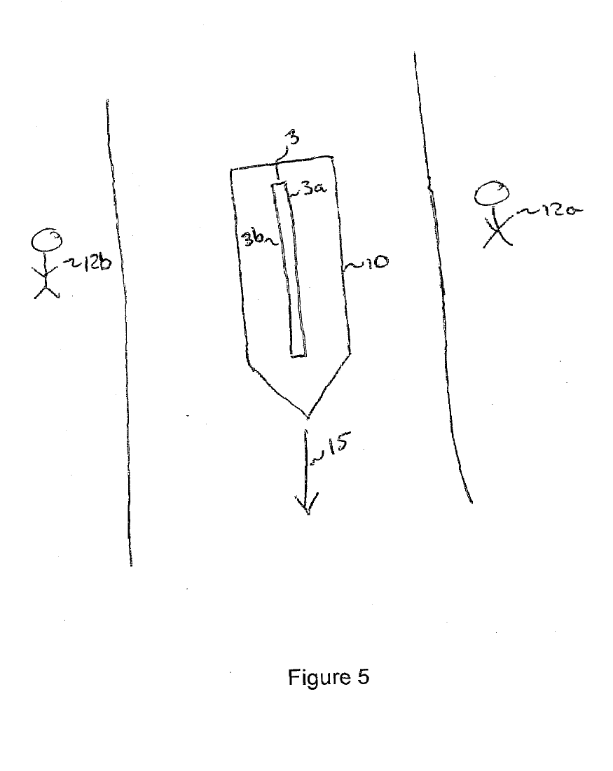

In the embodiment shown in FIGS. 3 and 4, the vehicle is a watercraft, such as a boat or barge, whereby the display screen 3 is either fixedly or movably mounted thereon. A watercraft is a desirable advertising conveyor because a much larger display can be provided thereon, in contrast to a taxi or a bus. If the display screen 3 is fixedly mounted thereon, then a heading of the watercraft is adjusted so that glare is minimized. Whereas, if the display screen 3 is movably mounted on the watercraft, then the position adjustment device 7 and/or a change in the heading of the watercraft can be utilized to alter the viewing angle 11 of the display screen 3, in order to minimize glare on the display screen 3.

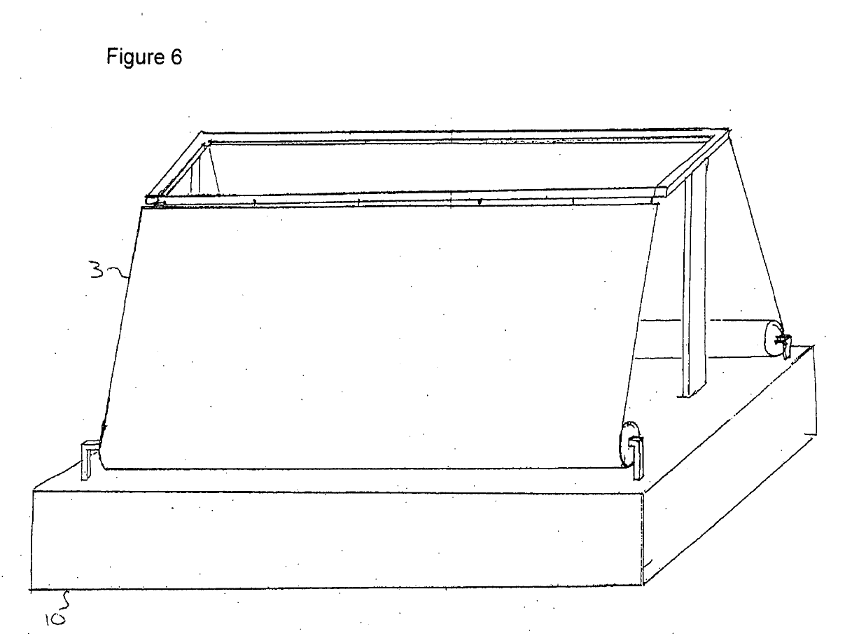

FIG. 5 illustrates an embodiment in which the advertising content on each side 3a, 3b of the display screen is determined on the basis of a heading 15 of the vehicle 10. Thus, different advertising content can be provided for the viewing audience 12a, 12b, based on the side 3a, 3b of the display screen 3 that they are viewing. The heading 15 can be determined, for example, from GPS signals, a compass, etc. In addition, the advertising content that is displayed on each side 3a, 3b of the display screen 3, can also be selected, for example, via an online auction.

FIG. 6 illustrates an embodiment, in which the display screen 3 is a revolving screen that has advertisement content printed onto the screen, which can be, for example a mesh screen. A mesh screen is particularly beneficial for use as a display screen 3 on a watercraft because the mesh reduces the effects of drift from wind. Thus, the stability and position of the watercraft can be more easily controlled.

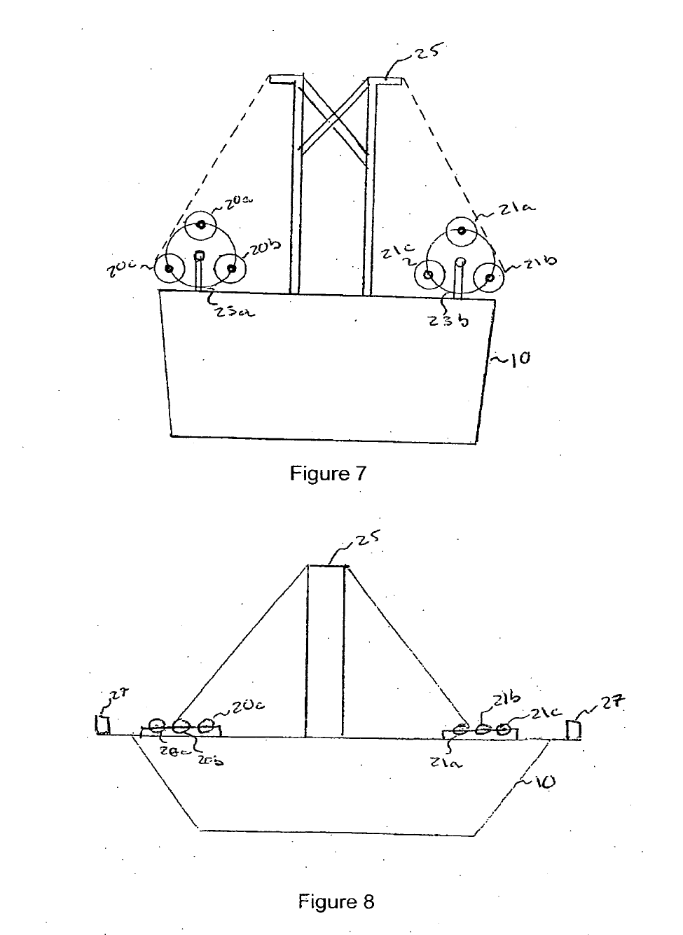

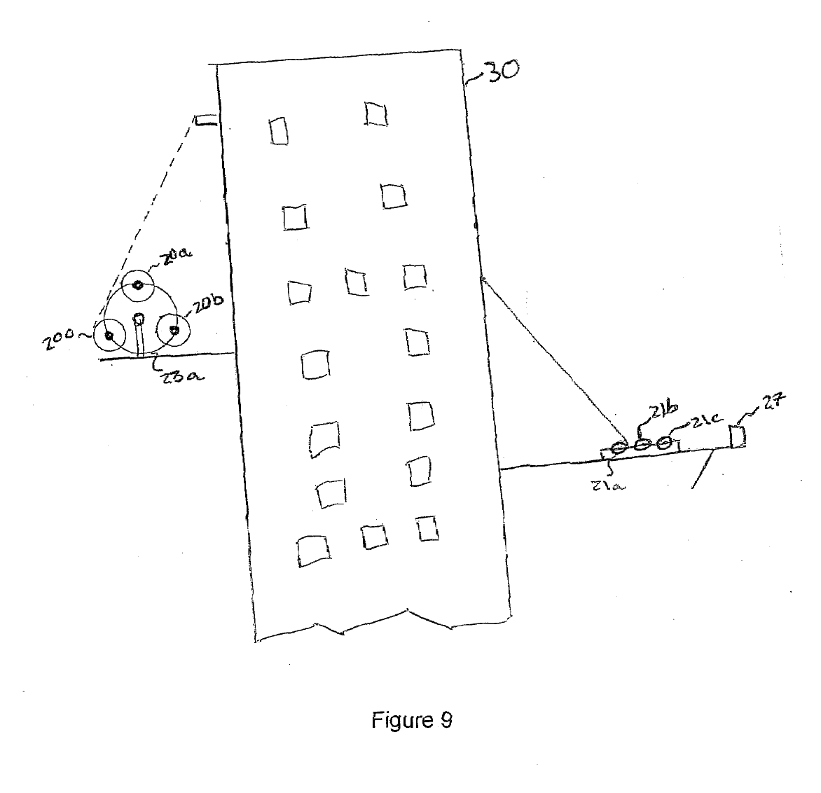

In another embodiment, a plurality of roller screens 20a-c and 21a-c, which can also be mesh screens, are provided on each side of the vehicle 10, which, as noted above, can be a watercraft. The roller screens 20a-c and 21a-c can be provided onto rollers 23a,b as shown in FIG. 7 or can be provided adjacent to one another as shown in FIG. 8. Each of the roller screens 20a-c and 21a-c can have different advertising content printed thereon or a coating for reflecting a projected image, whereby on the basis of the location of the watercraft, at least one of the screens is extended towards an upper cross member 25, in which the screen is fixedly held, in order to display the advertising content thereon.

A projector 27 can also be mounted onto the vehicle 10, in order to project advertising content onto a screen that does not have advertising content printed thereon, or to illuminate one of the extended roller screens 20a-c and 21a-c.

The roller screens 20a-c, 21a-c, or projector 27 can also be affixed to a building 30 or other structure, as illustrated in FIG. 9. Thus, via the substantially same support structure, different advertising content can be displayed by a quick extension interchange of the various roller screens.

Although detailed embodiments and implementations have been described above, it should be apparent that various modifications are possible. For example, different content can be selectively displayed on each display screen on the basis of one or more of incident radiation, watercraft position, current date and time, and/or on-demand content received through a network operatively connected to the controller. Multiple users may actively bid on and/or submit content for display on the watercraft. In this scenario, a user may submit content for display on a nearby watercraft through a client device, such as a computer, PDA, or mobile telecommunications device.

The content may be displayed on demand, e.g., in response to a specific user's request that is received through a network and approved for display, such as a user submitting content for customized display at a certain date/time and/or location. The content may be approved for display after having been filtered for profanity, content limitations such as a size or fonts, and/or after having received acceptable payment for the content, such as through a competitive on-line auction and/or after meeting a minimum purchase price. Users may also submit content for display during special events, such as sporting events, at various dates/times, such as weekday rush-hour periods, and/or upon the occurrence of designated events, e.g., travel, security, and/or missing person advisories or alerts can be displayed automatically through emergency networks and designated to supersede previously displayed content, such as an amber alert being broadcast to temporarily replace previously displayed content relating to an upcoming sporting event.

What is claimed is:

1. An advertisement display apparatus comprising:
a display screen for displaying advertising content;
at least one radiation intensity sensor for measuring incident radiation; and
a position adjustment device for adjusting a viewing angle of the display screen on the basis of the measured incident radiation to thereby minimize glare on the display screen.

2. The advertisement display apparatus according to claim 1, wherein the advertisement display apparatus is provided on a vehicle.

3. The advertisement display apparatus according to claim 2, wherein the advertisement display apparatus is fixedly mounted to the vehicle.

4. The advertisement display apparatus according to claim 3, wherein the display screen is a cathode ray tube, a liquid crystal display, a plasma display, an electrostatic marking film, a preprinted film, or a mesh screen.

5. The advertisement display apparatus according to claim 1, wherein a controller controls the advertising content that is displayed on the display screen.

6. The advertisement display apparatus according to claim 5, wherein the advertising content is stored within the controller or is provided to the controller via a network.

7. The advertisement display apparatus according to claim 1, wherein the advertising content that is displayed is displayed on the basis of a particular location and travel direction of the advertisement display apparatus.

8. The advertisement display apparatus according to claim 7, wherein the location and travel direction are determined on the basis of GPS signals.

9. A watercraft comprising:
a display apparatus being mounted on the watercraft, the display apparatus having at least two display screens such that each display screen is viewable from an opposite sides of the watercraft; and
a travel direction detector for detecting a travel direction of the watercraft;
wherein different advertising content is displayed on each display screen on the basis of a travel direction of the watercraft.

10. The watercraft according to claim 9, wherein each display screen is viewable from locations that are at least perpendicular to the travel direction of the watercraft.

11. The watercraft according to claim 9, wherein the display apparatus is an electronic display apparatus configured to selectively display different advertising content on each display screen on the basis of travel direction.

12. The watercraft according to claim 11, wherein the display apparatus is configured to selectively display different advertising content on each display screen on the basis of one or more of incident radiation, watercraft position, and current date and time.

13. The watercraft according to claim 9, wherein the display apparatus is configured to selectively display different advertising content on each display screen on the basis of one or more of incident radiation, watercraft position, and current date and time.

14. The watercraft according to claim 9, further comprising a controller, the controller being configured to selectively control the content of each of the display screens of the display apparatus.

15. The watercraft according to claim 14, wherein the controller is operatively connected to a network, the controller being configured to receive content for display on one or more of the display screens through the network.

16. The watercraft according to claim 15, wherein the display apparatus further comprises:
an upper cross member being rigidly mounted to the watercraft; and
the display screens comprise roller screens being provided on each side of the watercraft, at least one of the roller screens on each side having different advertising content printed thereon than another roller screen from the same side,
wherein at least one of the roller screens from each side of the watercraft is extended towards the upper cross member in order to display the advertising content printed thereon.

17. The display apparatus according to claim 16, wherein, based on a position of the watercraft, a direction of the watercraft, and/or a time of day, the roller mesh screens are automatically extended to display different advertising content.

18. The display apparatus according to claim 11, wherein the roller screens are mesh screens.

19. A method for displaying advertising content on a display apparatus mounted on a watercraft, the display apparatus having at least two display screens such that each display screen is viewable from opposite sides of the watercraft, the method comprising:
detecting a travel direction of the watercraft with a travel detection device;
receiving content for display on each of the display screens at a controller on the watercraft; and
displaying different content on each display screen on the basis of the travel direction of the watercraft.

20. The method according to claim 19, further comprising selectively displaying different advertising content on each display screen on the basis of one or more of incident radiation, watercraft position, current date and time, or on-demand content received through a network operatively connected to the controller.
